(19) United States
(12) Patent Application Publication
(10) Pub. No.: US 2026/0303327 A1
(43) Pub. Date: Oct. 1, 2026

(54) DATA TRANSFER PROTOCOL

(71) Applicant: Lenovo (United States) Inc., Morrisville, NC (US)

(72) Inventors: Igor Stolbikov, Apex, NC (US); Scott Li, Cary, NC (US); Rafael Rodrigues Machado, Sorocaba (BR); Irene Nunziata, Allen Park, MI (US)

(21) Appl. No.: 19/095,561

(22) Filed: Mar. 31, 2025

(51) Int. Cl. H04L 9/08; H04L 9/14; H04L 9/32; H04L 9/40

(52) U.S. Cl. CPC H04L 9/083; H04L 9/088; H04L 9/14; H04L 9/321; H04L 63/0471

(57) ABSTRACT

One embodiment provides a method, the method including: transmitting, from an intermediary device, a set of encryption keys corresponding to the third device to the second device, wherein the second device is trusted by the intermediary device and wherein the intermediary device is trusted by the third device; receiving, at the intermediary device from the third device, an ephemeral set of encryption keys and an encapsulated secret; receiving, at the intermediary device from the second device, a data payload including encrypted content and a key corresponding to the second device, wherein the encrypted content is encrypted by the second device using an encryption key corresponding to the second device and a key of the set of encryption keys corresponding to the third device and the encapsulated secret; and transmitting, from the intermediary device to the third device, the data payload, wherein the transmitting includes signing, by the intermediary device, the data payload.

### BACKGROUND

Transferring data from one device to another requires a connection between the devices. Such a connection may be a physical, wired connection, may be a wireless connection, or even an indirect connection that allows the devices to communicate with each other. However, many times information needs to be communicated that is sensitive or that should not be shared with other parties. In such situations, the information may be encrypted or otherwise obfuscated so that other parties who may access the information cannot accurately identify or read the information. Many encryption techniques utilize keys that are shared with the devices that are intending to communicate. Each device may have a set of keys, with one of the keys being shared with the other device. Utilizing the keys, the information can be encrypted and decrypted by the devices in communication with each other.

### BRIEF SUMMARY

In summary, one aspect provides a method, the method including: transmitting, to a second device and from an intermediary device in operative communication with the second device and a third device, a set of encryption keys corresponding to the third device, wherein the second device is trusted by the intermediary device and wherein the intermediary device is trusted by the third device; receiving, at the intermediary device from the third device, an ephemeral set of encryption keys and an encapsulated secret; receiving, at the intermediary device from the second device, a data payload including encrypted content and a key corresponding to the second device, wherein the encrypted content is encrypted by the second device using an encryption key corresponding to the second device and a key of the set of encryption keys corresponding to the third device and the encapsulated secret; and transmitting, from the intermediary device to the third device, the data payload, wherein the transmitting includes signing, by the intermediary device, the data payload.

Another aspect provides a system, the system including: an intermediary device; a processor; a memory device that stores instructions that, when executed by the processor, causes the system to: transmit, to a second device and from the intermediary device in operative communication with the second device and a third device, a set of encryption keys corresponding to the third device, wherein the second device is trusted by the intermediary device and wherein the intermediary device is trusted by the third device; receive, at the intermediary device from the third device, an ephemeral set of encryption keys and an encapsulated secret; receive, at the intermediary device from the second device, a data payload including encrypted content and a key corresponding to the second device, wherein the encrypted content is encrypted by the second device using an encryption key corresponding to the second device and a key of the set of encryption keys corresponding to the third device and the encapsulated secret; and transmit, from the intermediary device to the third device, the data payload, wherein the transmitting includes signing, by the intermediary device, the data payload.

A further aspect provides a product, the product including: a computer-readable storage device that stores executable code that, when executed by a processor, causes the product to: transmit, to a second device and from an intermediary device in operative communication with the second device and a third device, a set of encryption keys corresponding to the third device, wherein the second device is trusted by the intermediary device and wherein the intermediary device is trusted by the third device; receive, at the intermediary device from the third device, an ephemeral set of encryption keys and an encapsulated secret; receive, at the intermediary device from the second device, a data payload including encrypted content and a key corresponding to the second device, wherein the encrypted content is encrypted by the second device using an encryption key corresponding to the second device and a key of the set of encryption keys corresponding to the third device and the encapsulated secret; and transmit, from the intermediary device to the third device, the data payload, wherein the transmitting includes signing, by the intermediary device, the data payload.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for transmitting information from a second device to a third device where trust is not established utilizing an intermediary device that is trusted by both the second and third device, while maintaining a privacy of the information from the intermediary device.

FIG. 4 illustrates an example flow of information between the intermediary device, the second device, and the third device.

### DETAILED DESCRIPTION

Generally, when two devices are in communication with each other, particularly to share sensitive information, the two devices have an established trust between them. This established trust is particularly useful when the two devices are going to communicate encrypted data and need to trade encryption keys. The devices do not want to trade encryption keys and, thereafter, encrypted information, without assurances that the keys and information will be used as expected. One technique for establishing trust between devices is to physically connect the devices. Physically connecting the devices can be used as a factor in establishing trust. Once the devices are physically connected, the network or system can then verify the security and compliance of the connected device, for example, through certificates, tokens, and/or the like. Thus, the trust can be established between the two connected devices and the devices can allow access to systems and/or information of the devices.

Another technique for establishing trust includes utilizing an authentication technique, where the user of the device provides credentials. These credentials can then be verified and the trust established upon a successful verification. In such a situation, the device itself may be previously known to another device. Additionally, the device may provide keys that can be used by the other device to verify the device is an expected device. Other techniques for establishing trust are possible. However, when multiple devices need to transmit information to a device, it can be difficult to ensure a trust connection can be established, particularly if the devices that can be connected may not be previously known to a device. Additionally, configurations that have hybrid schemas for end-to-end configuration may be in need of support. Such configurations may need to be able to transfer data from firmware to software, from software to firmware, from firmware to firmware, from software to software, and/or the like through a modality of devices. Such support is not currently available using traditional trust establishing techniques.

Accordingly, the described system and method provides a technique for transmitting information from a second device to a third device where trust is not established utilizing an intermediary device that is trusted by both the second device and the third device, while maintaining a privacy of the information from the intermediary device. The intermediary device is in communication with both the second device and the third device and the second device and third device can communicate with each other through the intermediary device. In order to establish the communication protocol, a set of encryption keys of the third device are transmitted to the second device from the intermediary device. The set of encryption keys may be signature keys of the third device. The third device may generate an ephemeral set of encryption keys and an encapsulated secret that are transmitted to and received by the intermediary device. The ephemeral set of encryption keys and encapsulated secret may be generated upon receiving an indication that a communication session between the second and third device is to be established.

The second device may generate a data payload that includes encrypted content and a key corresponding to the second device. To encrypt the content the second device utilizes at least one of the keys from a set of encryption keys corresponding to the second device and at least one of the keys from the set of encryption keys corresponding to the third device. The key corresponding to the third device may be encapsulated using an encapsulation key. This data payload may be received at the intermediary device. The intermediary device can verify that the data payload has been received from the second device, as a trusted device, sign the data payload, and then transmit the signed data payload to the third device. The third device can verify the signature corresponds to a trusted device. The third device, upon verifying the signature, can decapsulate the secret and decrypt the encrypted content. Thus, the system utilizes post-quantum encryption along with traditional encryption techniques to establish a secure transfer protocol between two devices that are untrusted via an intermediary device that is trusted by both of the two devices. Post-quantum encryption, or more generally, post-quantum cryptography (e.g., quantum-resistant cryptography) pertains to cryptographic systems that aim to be secure against quantum and classical computers, which may still provide for interoperation with existing communications protocols and networks.

Therefore, a system provides a technical improvement over traditional methods for the transmission of information. The described system utilizes an intermediary device that has both a trust connection to a second device and a trust connection to a third device to communicate information between the second and third device, even when a trust connection is not established between the second and third device. Thus, this provides a technique for communicating information between the second and third device that does not require the system to create a direct trust connection between the second and third device, thereby allowing the management of the trust connection to be maintained by an entity controlling the intermediary device instead of requiring the management of the trust connection at the second and/or third device. Additionally, the system communicates the information between the second and third device via the intermediary device in a way such that the privacy of the information is maintained and kept from the intermediary device. Thus, the intermediary device acts as a conduit between the second and third device and validates the trust connection, without being exposed to the information that is being transmitted.

Accordingly, the described system provides an innovated multi-party post-quantum secure data transfer protocol that could be used for many different use cases. The use of the combination of post-quantum cryptography based upon module lattices and traditional public key cryptography provides an aggregated strength of traditional and post-quantum cryptography. Additionally, this provides a strong non-separability of the attestations. Additionally, since this technique uses a message-based format, it is suitable for many different applications.

The illustrated example embodiments will be best understood by reference to the figures. The following description is intended only by way of example, and simply illustrates certain example embodiments.

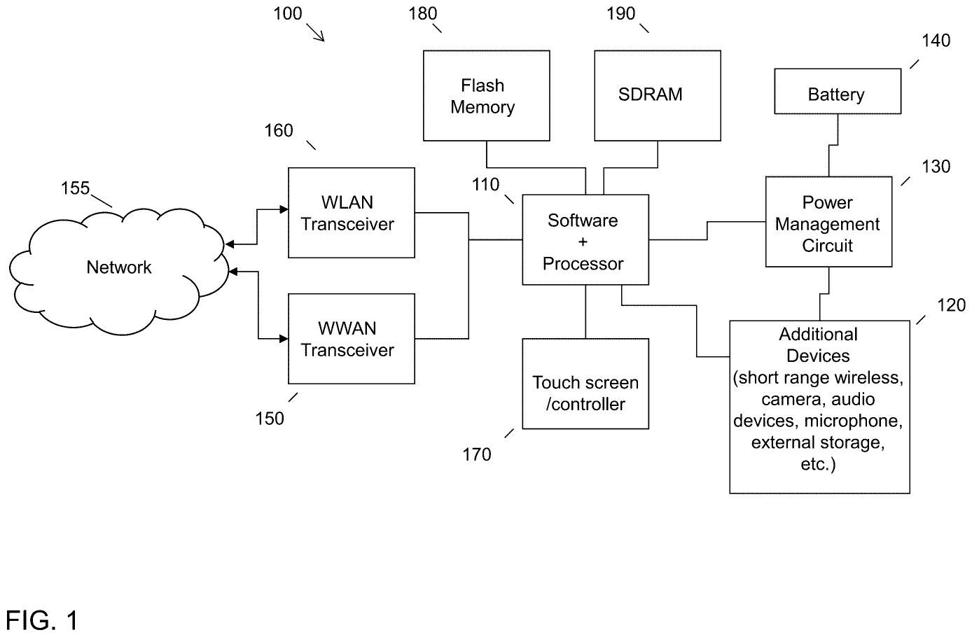

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

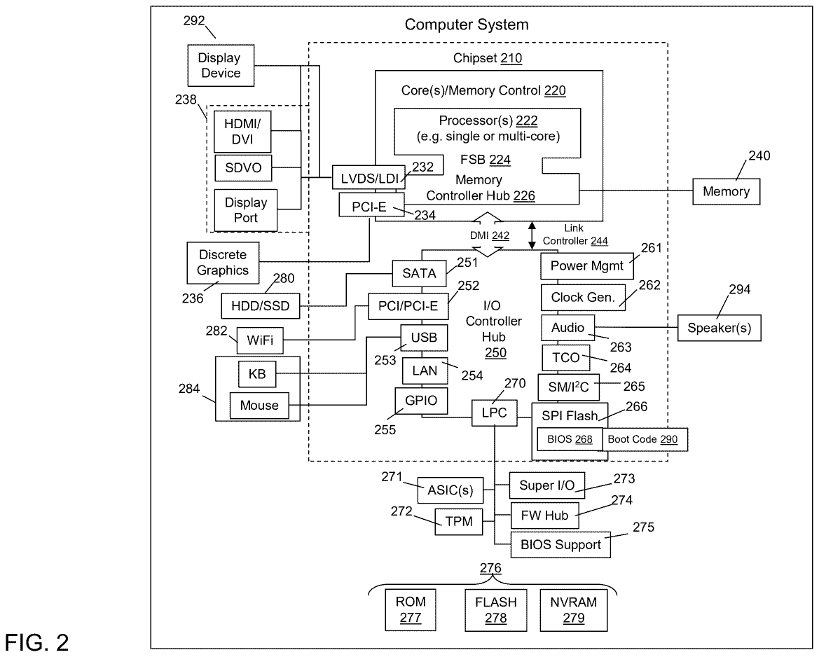

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support. As an example, a TPM may operate to perform one or more cryptographic functions. For example, a TPM may operate as a secure cryptoprocessor that implements the ISO/IEC 11889 standard. As an example, a TPM may provide for generation of one or more cryptographic keys (e.g., consider RSA key generation) and may provide for wrapping or binding of a key, which may help protect a key from disclosure. As an example, a TPM may provide for performing hashing (e.g., consider an SHA-1 hash generator, etc.) and, for example, one or more related functions.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices that are used to communicate with each other, devices that may act as intermediaries between devices, devices that house or provide access to the data transmission system, and/or the like. For example, the circuitry outlined in FIG. 1 may be implemented in a tablet or smart phone embodiment, whereas the circuitry outlined in FIG. 2 may be implemented in a personal computer embodiment.

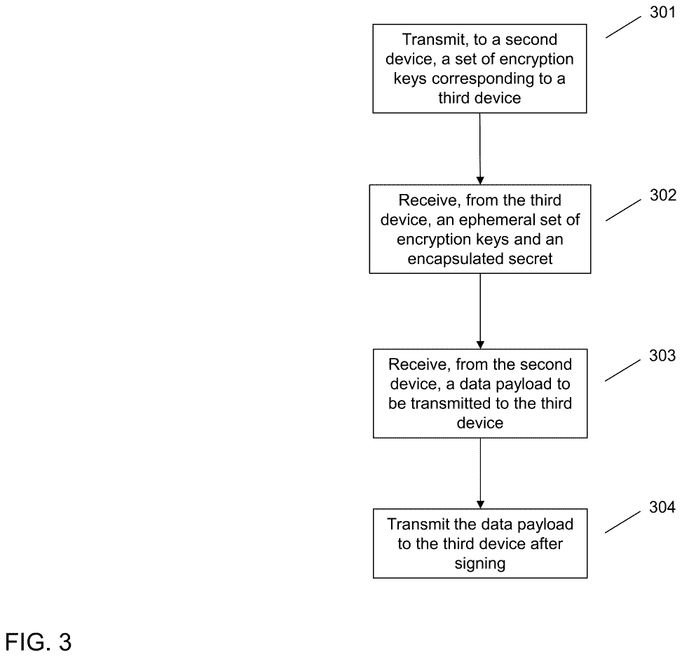

FIG. 3 illustrates an example method for transmitting information from a second device to a third device where trust is not established utilizing an intermediary device that is trusted by both the second and third device, while maintaining a privacy of the information from the intermediary device. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to securely transmit information between two devices utilizing an intermediary device. Additionally, the data transmission system includes modules and features that are unique to the described system.

The data transmission system may be activated in order to transfer or communication information between two devices that are untrusted utilizing an intermediary device that has an established trust with each of the two devices. Thus, the data transmission system may be activated upon detection of an indication that information is to be transmitted between the two devices. As an example, a second device, also referred to as a child device for ease of readability, may be connected to the intermediary device and provide an indication that information should be communicated to a third device. The third device will be referred to as a cloud device for ease of readability, but the third device could be any type of device, not just a cloud device. Since the intermediary device has an established trust between both the child device and the cloud device, the intermediary device can attest to the trustworthiness of information that is being transmitted to/from the child device and the cloud device, thereby allowing information to be transmitted between the child device and the cloud device without the child device and the cloud device having to establish a direct trust connection.

Activation of the data transmission system may be a manual activation of the data transmission system and/or an automatic activation of the data transmission system. Manual activation of the system may include a user opening an application associated with the data transmission system, the user accessing the computing system associated with the data transmission system, and/or the user otherwise providing input to the data transmission system. The automatic activation of the data transmission system may be based upon the detection of a trigger event indicating that the system should be activated. Example trigger events include a user of a child device attempting to transmit information to the cloud device, a cloud device attempting to transmit information to a child device, the intermediary device establishing a trust connection between both a child device and a cloud device, a user accessing an application that interfaces with the data transmission system, activation of software or an application utilizing the data transmission system, and/or the like.

The data transmission system may be made of multiple systems or modules that communicate together to make up the data transmission system or may be a single system. The data transmission system may be a standalone system, may be accessible through other computing devices, and/or a combination thereof. For example, the data transmission system may be a standalone system that can be accessed by a user and/or may be or provide an application that is accessible by a user on another computing device. The data transmission system may be accessible using any type of computing device, for example, personal computer, laptop computer, smartphone, tablet, smartwatch, head-mounted display, smart television or other smart appliance, augmented reality device, virtual reality device, and/or the like.

Thus, the data transmission system may be accessible locally using a computing device where the data transmission system is installed and/or may be accessible remotely through another computing device. For example, the data transmission system may be accessed by a user using a device that communicates with the data transmission system to transmit information between the child device and the cloud device, to establish an intermediary device, to establish a trust connection between the intermediary device and the child device, to establish a trust connection between the intermediary device and the cloud device, as a child device, as a cloud device, and/or the like. However, the data transmission system may be located and operate on a different information handling device to perform the described steps.

The data transmission system may include different components for carrying out different functions of the system, including different steps to be performed. These components may be hardware components or software components. Some hardware devices or components that may be utilized by the data transmission system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the data transmission system. For example, the data transmission system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the data transmission system, and/or the like.

One software component may include a data storage location or data repository that stores information related to devices having an established trust connection, authentication information, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by device, grouped by user, grouped by authentication information, and/or the like.

For ease of readability, there will be three devices that are discussed, an intermediary device, a second device, and a third device. For ease of readability, the second device will be referred to as the child device, the third device will be referred to as the cloud device, and the intermediary device may be referred to as a management device. However, it should be noted that more than three devices can be utilized. For example, there may be more than one child device, more than one cloud device, more than one intermediary device, and/or the like.

Additionally, it is described that a child device communicates with an intermediary device that communicates with the cloud device. However, there could be additional intermediary devices. For example, a child device might communicate with an intermediary device that communicates with another intermediary device that communicates with the cloud device. Within the communication protocol or chain, the intermediary devices will have an established trust connection with two devices, with the child device and the cloud device each having a single established trust connection, with that trust connection being with an intermediary device. In other words, the child device and the cloud device do not have an established trust connection with each other. Stated differently, the child device and the cloud device do not trust each other.

To establish a trust connection between the management device and the child device, the child device is physically connected to the management device. While a physical connection is discussed, it should be noted that this physical connection may not be a direct physical connection. The physical connection may simply be a connection that allows for a trust communication session between the child device and the management device. Establishing this trust connection may be performed using any traditional technique. The trust connection puts the child device and the management device in operative communication with one another.

To establish a trust connection between the management device and the cloud device, the management device may be authenticated by an authentication system. This authentication may be through traditional authentication techniques, for example, credentials, two-factor authentication, biometric authentication, and/or the like, or a combination thereof. Upon authenticating the management device using the authentication system, a single-sign on communication session is established between the management device and the cloud device, thereby establishing a trust connection between the two devices. This trust connection puts the cloud device and the management device in operative communication with one another.

The cloud device generates signing keys for the cloud device. The generation of the cloud signing keys can occur either before or after the establishment of the trust connection between the management device and the cloud device. The cloud signing keys may include traditional encryption keys, for example, elliptic curve cryptography (ECC) keys, Rivest-Shamir-Adleman (RSA) keys, digital signature algorithm (DSA) keys, and/or any other type of cryptography algorithm that utilizes public keys. The cloud signing keys may also include a post-quantum cryptography key. The cloud signing keys may be published and at least a portion of them may be shared with other devices, as needed.

Upon establishing the authenticated session or trust session with the cloud device, the management device may generate traditional encryption keys and post-quantum cryptography keys as a set of signing keys. The public key of these key pairs of the management device are transmitted and shared with the cloud device. The cloud device then maintains a record of the public key of the management device's signing keys for validation of any information that is indicated as being signed by the management device.

The key generation may be performed by generating private and public keys from a common secure seed value, which may be a device composite identity, physically unclonable function (PUF), and/or the like. The keys may be augmented with unique randomness to make them more secure and less prone to being guessed or derived, even if device identity information is known, for example, using salting, stretching, and/or the like, techniques. The keys that may be generated may include module lattice based encapsulation public and private key pair, an elliptic curve key, a module lattice based signature public and private key pair, an elliptic curve key signing key, and/or the like. While these examples are utilized, it should be noted that other types of keys can be generated, for example, any type of encapsulation public and private key pair, a traditional public key, a public and private key pair for device signatures, signing keys, and/or the like. The keys that are generated are non-deterministic keys and are not guessable keys.

At 301, the intermediary device of the data transmission system transmits, to the second device, a set of encryption keys corresponding to the third device. In other words, the management device transmits keys generated by the cloud device to the child device. As mentioned the intermediary device is in operative communication with the second device and the third device, and the intermediary device has a trust connection with both the second device and the third device, even though the second device and the third device do not have a trust connection therebetween. The keys that are transmitted to the child device from the management device include the cloud signing keys. These cloud signing keys may be provided at the time that the communication session is initiated between the management device and the child device, may be provided after an indication that a communication session should be initiated between the child device and the cloud device via the management device, and/or the like. The cloud signing keys may be provided via a hardcoded process or provided through the trusted process. The cloud signing keys that are transmitted from the management device to the child device may include the public keys of the cloud device.

At 302, the intermediary device may receive, from the third device, an ephemeral set of encryption keys and an encapsulated secret. In other words, the cloud device may transmit to the management device an ephemeral set of encryption keys and an encapsulated secret. The cloud device may generate the ephemeral set of encryption keys and the encapsulated secret upon receipt of an indication to establish a communication session between the second device and the third device, or the child device and the cloud device. In other words, the ephemeral set of encryption keys and the encapsulated secret may be generated by the cloud device after the child device initiates a communication connection between the child device and the cloud device, via the management device. As part of the initiation of the communication session, the ephemeral set of encryption keys and the encapsulated secret are generated by the cloud device and transmitted to the management device. The set of encryption keys may be a traditional set of encryption keys, for example, ECC keys, RSA keys, DSA keys, and/or the like. The secret is encapsulated by the cloud device using the post-quantum key of the cloud device.

The ephemeral set of encryption keys and the encapsulated secret are transmitted from the management device to the child device. The child device can verify the signature of the ephemeral set of encryption keys and the encapsulated secret based upon the cloud signing keys that were previously provided to the child device. This verification allows the child device to determine that the ephemeral set of encryption keys and the encapsulated secret was actually generated by the cloud device, thereby allowing the child device to trust the ephemeral set of encryption keys and the encapsulated secret. This encapsulated secret will be referred to as X1 for ease of readability.

Once the child device has received the ephemeral set of encryption keys and the encapsulated secret, the child device can utilize this information to encrypt content to transmit to the cloud device through the management device. The child device calculates shared secret, X2, using encryption keys, with one of the encryption keys corresponding to the child device and one of the encryption keys corresponding to the cloud device. For example, to calculate the shared secret, X2, the child device may use a private key of a public/private key pair of the child device and the public key of a public/private key pair of the cloud device. The public key of the cloud device was provided to the child device from the management device previously. The child device then calculates a shared key derivative function (KDF) from the encapsulated secret X1 and the calculated secret X2. The resulting KDF is effectively a random number that can be used to encrypt the content the child device wants to transmit to the cloud device. Accordingly, the content can be encrypted utilizing the secrets, X1 and X2, shared between the child device and the cloud device. Thus, the child device is able to encrypt content to be transmitted to the cloud device, via the management device, using an encryption key corresponding to the child device and a key of the set of encryption keys corresponding to the cloud device and the encapsulated secret.

At 303, the intermediary device receives, from the second device, a data payload including the encrypted content and a key corresponding to the second device. In other words, the child device transmits the content encrypted by the child device and a key to the management device. Additionally, the child device may transmit the original encapsulated secret, X1, that was encapsulated by the cloud device. In other words, the data payload may also include the original encapsulated secret, X1. Accordingly, the data payload may include a key corresponding to the child device, for example, a public key corresponding to the child device, the encapsulated secret, X1, and the encrypted content. The management device signs the data payload. The signing of the data payload is an attestation that the data payload was received by the management device from a device that is trusted by the management device. The management device uses its signing keys to sign the data payload. As previously mentioned, these signing keys are known to the cloud device.

At 304, the intermediary device transmits, to the third device, the data payload that was signed by the intermediary device. In other words, the management device transmits the signed data payload to the cloud device. Upon receiving the signed data payload, the cloud device verifies the signature that was used to sign the data payload. This verification allows the cloud device to verify that the signed data payload is being received from a device that is trusted by the cloud device. The verification by the cloud can be performed based upon the management device signing keys that were provided to or are known by the cloud device. The cloud device can perform an attestation verification using the known management device signing keys to verify that the signature on the data payload corresponds to the management device.

Upon successful verification of the signatures that were used to sign the data payload, the cloud device can attempt to decrypt the data payload. A successful verification is a confirmation that the signature used to sign the data payload corresponds to the management device or a device that is trusted by the cloud device. Upon an unsuccessful verification, meaning the signatures cannot be verified as belonging to a trusted device, the cloud device may discard the data payload or otherwise not attempt to decrypt the data payload. To decrypt the data payload, the cloud device may first decapsulate the encapsulated secret, X1. Since the secret was encapsulated by the cloud device, the cloud device may utilize a private key of the cloud device to decapsulate the secret. The private key that is utilized may be the private key of the post-quantum encryption key pair of the cloud device.

The cloud device may then calculate the shared secret, X2, using encryption keys, with one of the encryption keys corresponding to the child device and one of the encryption keys corresponding to the cloud device. This shared secret is the same shared secret that was calculated by the child device and that was used for a step of the encryption process. For example, to calculate the shared secret, X2, the cloud device may use a private key of a public/private key pair of the cloud device and the public key of a public/private key pair of the child device. The public key of the child device was provided to the cloud device within the data payload. Once the shared secret, X2, has been calculated by the cloud device, the cloud device can calculate the shared KDF value from the shared secrets, X1 and X2. This shared KDF value will be the same KDF value that was calculated by the child device when encrypting the content. Once the KDF value has been calculated by the cloud device, the cloud device can decrypt the encrypted content.

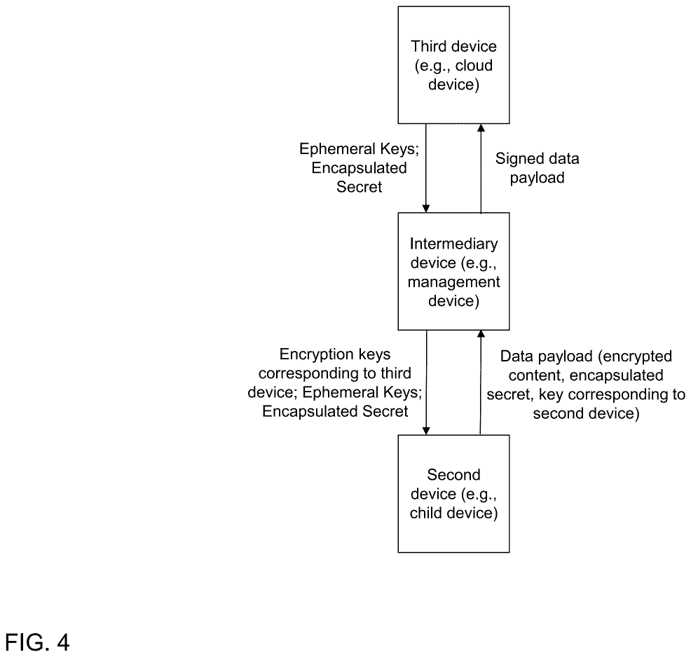

FIG. 4 illustrates an overall, non-limiting example of the flow of information between the three devices. The second device (e.g., the child device) wants to transmit information to the third device (e.g., a cloud device). However, the child device and the cloud device do not have an established trust relationship. The child device and the cloud device do, however, have a trust relationship with the intermediary device (e.g., a management device). Thus, the management device can be used as an intermediary to transmit information between the cloud device and the child device and provide attestations that the information being received from the management device by either the child device or the cloud device is from a device trusted by the management device.

To establish the data transfer protocol between the cloud device and the child device via the management device, the cloud device transmits ephemeral keys and an encapsulated secret to the management device. The management device transmits the ephemeral keys and the encapsulated secret to the child device. The management device also provides encryption keys, or signing keys, of the cloud device to the child device. The signing keys may be provided separately from the ephemeral keys and encapsulated secret. For example, the signing keys may be provided upon a connection of the child device to the management device, may be provided upon an indication that a communication session should be established between the child device and the cloud device, and/or the like.

Using the ephemeral keys and the encapsulated secret, the child device creates a data payload including the encrypted content, the encapsulated secret, and a key corresponding to the second device. The data payload is transmitted to the management device. The management device signs the data payload as an attestation that the data payload was received from a device trusted by the management device. The management device then transmits the signed data payload to the cloud device. The cloud device can utilize the information contained within the data payload and information known by the cloud device to decrypt the content, after verifying the signature of the signed data payload corresponds to a trusted device.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
transmitting, to a second device and from an intermediary device in operative communication with the second device and a third device, a set of encryption keys corresponding to the third device, wherein the second device is trusted by the intermediary device and wherein the intermediary device is trusted by the third device;
receiving, at the intermediary device from the third device, an ephemeral set of encryption keys and an encapsulated secret;
receiving, at the intermediary device from the second device, a data payload comprising encrypted content and a key corresponding to the second device, wherein the encrypted content is encrypted by the second device using an encryption key corresponding to the second device and a key of the set of encryption keys corresponding to the third device and the encapsulated secret; and
transmitting, from the intermediary device to the third device, the data payload, wherein the transmitting comprises signing, by the intermediary device, the data payload.

2. The method of claim 1, wherein the operative communication between the intermediary device and the second device comprises a physical communication medium, wherein the physical communication medium establishes trust between the intermediary device and the second device.

3. The method of claim 1, wherein establishing trust between the intermediary device and the third device comprises a user being authenticated at the intermediary device and transmitting at least one key of at least one key pair of the intermediary device to the third device.

4. The method of claim 1, wherein the ephemeral set of encryption keys and the encapsulated secret are generated upon receipt of an indication to establish a communication session between the second device and the third device.

5. The method of claim 1, wherein the encapsulated secret is encapsulated using a key of the set of encryption keys corresponding to the third device.

6. The method of claim 1, wherein the encrypted content is encrypted utilizing a random number.

7. The method of claim 6, wherein the random number is derived from secrets shared between the second device and the third device.

8. The method of claim 1, wherein the third device decrypts the encrypted content utilizing a function derived from secrets shared between the second device and the third device.

9. The method of claim 1, wherein the data payload comprises a key of the set of encryption keys corresponding to the third device.

10. The method of claim 1, wherein the second device and the third device do not have an established trust.

11. A system, the system comprising:
an intermediary device;
a processor;
a memory device that stores instructions that, when executed by the processor, causes the system to:
transmit, to a second device and from the intermediary device in operative communication with the second device and a third device, a set of encryption keys corresponding to the third device, wherein the second device is trusted by the intermediary device and wherein the intermediary device is trusted by the third device;
receive, at the intermediary device from the third device, an ephemeral set of encryption keys and an encapsulated secret;
receive, at the intermediary device from the second device, a data payload comprising encrypted content and a key corresponding to the second device, wherein the encrypted content is encrypted by the second device using an encryption key corresponding to the second device and a key of the set of encryption keys corresponding to the third device and the encapsulated secret; and
transmit, from the intermediary device to the third device, the data payload, wherein the transmitting comprises signing, by the intermediary device, the data payload.

12. The system of claim 11, wherein the operative communication between the intermediary device and the second device comprises a physical communication medium, wherein the physical communication medium establishes trust between the intermediary device and the second device.

13. The system of claim 11, wherein establishing trust between the intermediary device and the third device comprises a user being authenticated at the intermediary device and transmitting at least one key of at least one key pair of the intermediary device to the third device.

14. The system of claim 11, wherein the ephemeral set of encryption keys and the encapsulated secret are generated upon receipt of an indication to establish a communication session between the second device and the third device.

15. The system of claim 11, wherein the encapsulated secret is encapsulated using a key of the set of encryption keys corresponding to the third device.

16. The system of claim 11, wherein the encrypted content is encrypted utilizing a random number.

17. The system of claim 16, wherein the random number is derived from secrets shared between the second device and the third device.

18. The system of claim 11, wherein the third device decrypts the encrypted content utilizing a function derived from secrets shared between the second device and the third device.

19. The system of claim 11, wherein the data payload comprises a key of the set of encryption keys corresponding to the third device.

20. A product, the product comprising:
a computer-readable storage device that stores executable code that, when executed by a processor, causes the product to:
transmit, to a second device and from an intermediary device in operative communication with the second device and a third device, a set of encryption keys corresponding to the third device, wherein the second device is trusted by the intermediary device and wherein the intermediary device is trusted by the third device;
receive, at the intermediary device from the third device, an ephemeral set of encryption keys and an encapsulated secret;
receive, at the intermediary device from the second device, a data payload comprising encrypted content and a key corresponding to the second device, wherein the encrypted content is encrypted by the second device using an encryption key corresponding to the second device and a key of the set of encryption keys corresponding to the third device and the encapsulated secret; and
transmit, from the intermediary device to the third device, the data payload, wherein the transmitting comprises signing, by the intermediary device, the data payload.
